(19) United States
(12) Patent Application Publication
(10) Pub. No.: US 2007/0240596 A1
(43) Pub. Date: Oct. 18, 2007

(54) Color filter and method for manufacturing same

(75) Inventors: Wei-Yuan Chen, Hsinchu (TW); Yu-Ning Wang, Hsinchu (TW); Ching-Yu Chou, Hsinchu (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: ICF Technology Co., Ltd., Hsinchu (TW)

(21) Appl. No.: 11/309,935

(22) Filed: Oct. 31, 2006

(30) Foreign Application Priority Data
Apr. 14, 2006 (TW) 095113369

(51) Int. Cl. B41C 1/12

(52) U.S. Cl. 101/483; 101/488; 359/885

(57) ABSTRACT

A color filter (100) includes a substrate, a black matrix formed on the substrate, and a plurality of color stripes. The black matrix defines a plurality of spaces therein, and the black matrix includes carbon black in a proportion by weight from 5% to 55%, polymer in a proportion by weight from 15% to 95%, and additives in a proportion by weight of less than or equal to 40%. The plurality of color stripes are formed by a ink-jet process in the spaces. A method for manufacturing a color filter is also provided.

### TECHNICAL FIELD

The present invention generally relates to color filters and, more particularly, to a color filter and a method for manufacturing the same.

### DISCUSSION OF RELATED ART

At present, liquid crystal displays (LCDs) are used in various products, such as notebook personal computers (PCs), mobile phones, desktop monitors, and digital cameras, because of their excellent characteristics, such as low weight, thinness, and low power consumption. The LCD includes a color filter for displaying color images. For the LCD to have color capability, each sub-pixel thereof is aligned with a color filter area, typically red, green, or blue, of the color filter. Depending upon the image to be displayed, one or more sub-pixel electrodes are energized during display operation to allow all the incident light, none of the incident light, or part of the incident light to be transmitted through the color filter area associated with that sub-pixel. The image perceived by a user is a blend of colors formed by the transmission of light through adjacent color filter areas.

In a color filter, a black matrix is used for isolating color stripes. A material of the black matrix is metallic material such as chromium and chromium alloy, or organic material such as resin-based composition containing carbon black. However, chromium is harmful to the environment as it is a heavy metal and is toxic to living organisms. Therefore, organic material may be substituted for the metallic material.

In a conventional method for manufacturing a color filter, the black matrix is formed by exposing and developing a photoresist layer of organic material. To expose the photoresist layer completely, the photoresist layer is required to be thin while optical density is required to be high. However, smoothness of the resulting black matrix is not satisfactory because carbon black contained in the organic material is difficult to remove through developing, and is in a discontinuous phase. When ink is deposited into the spaces defined by the black matrix, the ink easily climbs up and over the black matrix. Therefore, different-color inks may become mixed. To solve this problem, the conventional ink-jet method applying banks formed on the top of the black matrix. Therefore, this complicates the manufacturing process and the benefit of the simplicity of the ink-jet method decreases.

What is needed, therefore, is a color filter with new material for the black matrix and a method for manufacturing a color filter.

### SUMMARY OF THE INVENTION

A color filter according to one preferred embodiment includes a substrate; a black matrix formed on the substrate, the black matrix defining a plurality of spaces therein; and a plurality of color stripes respectively formed in the spaces. The black matrix has a composition including: carbon black in a proportion by weight from 5% to 55%; polymer in a proportion by weight from 15% to 95%; and additives in a proportion by weight of less than or equal to 40%.

A method for manufacturing a color filter according to another preferred embodiment includes the steps of: forming a black matrix on a substrate, the black matrix having a composition including: carbon black in a proportion by weight from 5% to 55%; polymer in a proportion by weight from 15% to 95%; and additives in a proportion by weight of less than or equal to 40%, the black matrix defining a plurality of spaces therein; depositing ink in the plurality of spaces; and solidifying the ink to form a plurality of color stripes.

A method for manufacturing a color filter according to another preferred embodiment includes the steps of: providing a photoresist material including carbon black in a proportion of the solidifiable content by weight from 5% to 55%; a material selected from the group consisting of monomer, oligomer, and polymer, in an proportion of the solidifiable content by weight from 15% to 95%; and additives in a proportion of the solidifiable content by weight of less than or equal to 40%. The photoresist material is then applied onto a substrate. A black matrix is then formed using a photolithographic process, the black matrix defining a plurality of spaces therein; depositing ink in the plurality of spaces; and solidifying the ink to form a plurality of color stripes.

Advantages and novel features will become more apparent from the following detailed description of the present color filter and its related method, when taken in conjunction with the accompanying drawings.

### BRIEF DESCRIPTION OF THE DRAWINGS

Many aspects of the present color filter and its related manufacturing method can be better understood with reference to the following drawings. The components in the drawings are not necessarily drawn to scale, the emphasis instead being placed upon clearly illustrating the principles of the present color filter and its related manufacturing method. Moreover, in the drawings, like reference numerals designate corresponding parts throughout the several views.

FIG. 1 is a cross-sectional view of a color filter in accordance with a first preferred embodiment; and

FIGS. 2 to 6 illustrate a manufacturing method of a color filter in accordance with a second preferred embodiment.

Corresponding reference characters indicate corresponding parts throughout the drawings. The exemplifications set out herein illustrate at least one preferred embodiment of the present color filter and its related method, in one form, and such exemplifications are not to be construed as limiting the scope of the invention in any manner.

### DETAILED DESCRIPTION OF THE INVENTION

Reference will now be made to the drawings to describe preferred embodiments of the present color filter and its related manufacturing method, in detail.

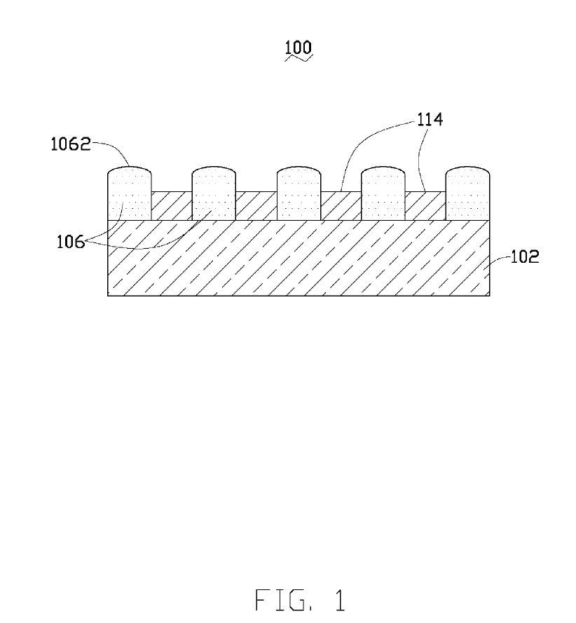

Referring to FIG. 1, a color filter 100 in accordance with a first preferred embodiment is shown. The color filter 100 includes a substrate 102, a black matrix 106 formed on the substrate 102, and a plurality of color stripes 114 formed in spaces defined by the black matrix 106.

Preferably, the substrate 102 is a glass substrate. Preferably, a material of the black matrix 106 is a resin-based composition containing carbon black. The black matrix 106 defines a plurality of spaces therein, and the spaces are arranged in rows and columns on the color filter 100.

The black matrix 106 includes: carbon black in a proportion by weight from 5% to 55%, and is preferably about 1 5% to 45%; polymer in a proportion by weight from 1 5% to 95%, and is preferably about 25% to 85%; and additives in a proportion by weight of less than or equal to 40%. A thickness of the black matrix is in the approximate range from 1.2 to 10 microns, and is preferably about 1.5 to 6 microns.

The additives include an initiator and/or dispersant after reaction which remains in the black matrix. The initiator includes a photo initiator. The photo initiator is selected from the group consisting of 4,4-bis(dimethylamino)benzophenone, 4,4′-bis(diethylamino)benzophenone, 2-(4-methoxyphenyl)-4,6-bis(trichloromethyl)-1,3,5-triazine, and tris(trichloromethyl)-1,3,5-triazine. Photo initiators currently in use include IRGACURE® 819, IRGACURE® 369, IRGACURE® 2959, IRGACURE® 379, IRGACURE® 184, IRGACURE® 784, IRGACURE® 250, IRGACURE® 907, IRGACURE® 651, IRGACURE® OXE01, IRGACURE® 500, IRGACURE® 1800, IRGACURE® 1000, IRGACURE® 1700, DAROCURE® BP, DAROCURE® 1173 CGI 242, DAROCURE® 1173 CGI-552, products of Ciba Specialty Chemicals, JP, Chivacure® TPO, Chivacure® TPO-L, Chivacure® 200, Chivacure® 107, Chivacure® 184, Chivacure® 284, products of Double Bond Chemical IND., CO., LTD, TAIWAN.

The polymer is selected from the group consisting of resin, and polymer formed by monomer or oligomer reacting with the initiator. The resin includes polymethyl methacrylate (PMMA). The monomer or oligomer is selected from the group consisting of trimethylolpropane triacrylate, pentaerythritol triacrylate, pentaerythritol tetraacrylate, dipentaerythritol hexaacrylate, dipentaerythritol hexysaacrylate or any combination thereof.

A few exemplary compositions for the black matrix 106 according to the first preferred embodiment follow:

A first composition for the black matrix 106 includes: carbon black in a proportion by weight of 15%, polymer made of polymethyl methacrylate (PMMA) in a proportion by weight of 38%, polymer made of dipentaerythritol hexaacrylate and photo initiator in a proportion by weight of 42%, and dispersant in a proportion by weight of 5%.

A second composition for the black matrix includes: carbon black in a proportion by weight of 20%, polymer made of PMMA in a proportion by weight of 44%, polymer made of dipentaerythritol hexysaacrylate and photo initiator in a proportion by weight of 30%, and dispersant in a proportion by weight of 6%.

A third composition for the black matrix 106 includes: carbon black in a proportion by weight of 25%, polymer made of PMMA in a proportion by weight of 35%, polymer made of dipentaerythritol hexaacrylate and photo initiator in a proportion by weight of 35%, and dispersant in a proportion by weight of 5%.

A fourth composition for the black matrix 106 includes: carbon black in a proportion by weight of 35%, polymer made of PMMA in a proportion by weight of 33%, polymer made of trimethylolpropane triacrylate and photo initiator in a proportion by weight of 22%, dispersant in a proportion by weight of 9.5%, and remained photo initiator in a proportion by weight of 0.5%.

A fifth composition for the black matrix 106 includes: carbon black in a proportion by weight of 40%, polymer made of PMMA in a proportion by weight of 35%, polymer made of pentaerythritol tetraacrylate and photo initiator in a proportion by weight of 15%, and dispersant in a proportion by weight of 10%.

A sixth composition for the black matrix 106 includes: carbon black in a proportion by weight of 45%, polymer made of PMMA in a proportion by weight of 29%, polymer made of pentaerythritol triacrylate and photo initiator in a proportion by weight of 14%, and dispersant in a proportion by weight of 12%.

A seventh composition for the black matrix 106 includes: carbon black in a proportion by weight of 52%, polymer made of PMMA in a proportion by weight of 10%, polymer made of trimethylolpropane triacrylate and photo initiator in a proportion by weight of 25%, and dispersant in a proportion by weight of 13%.

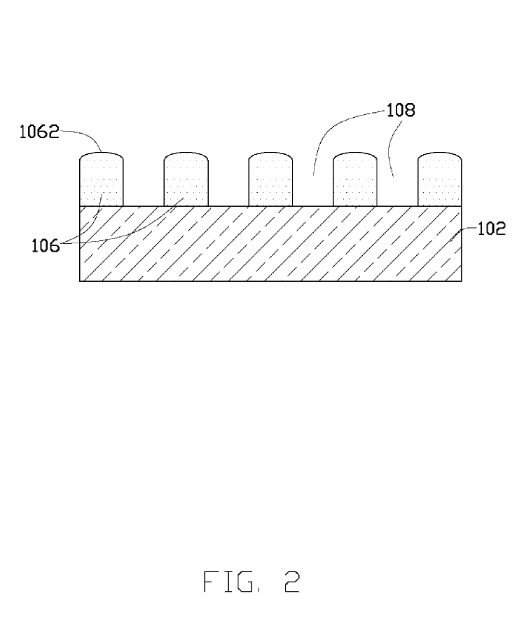

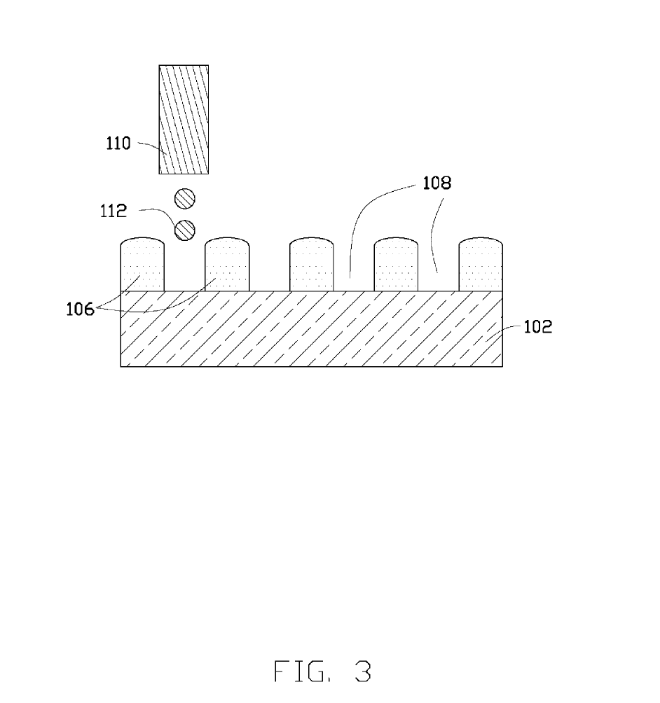

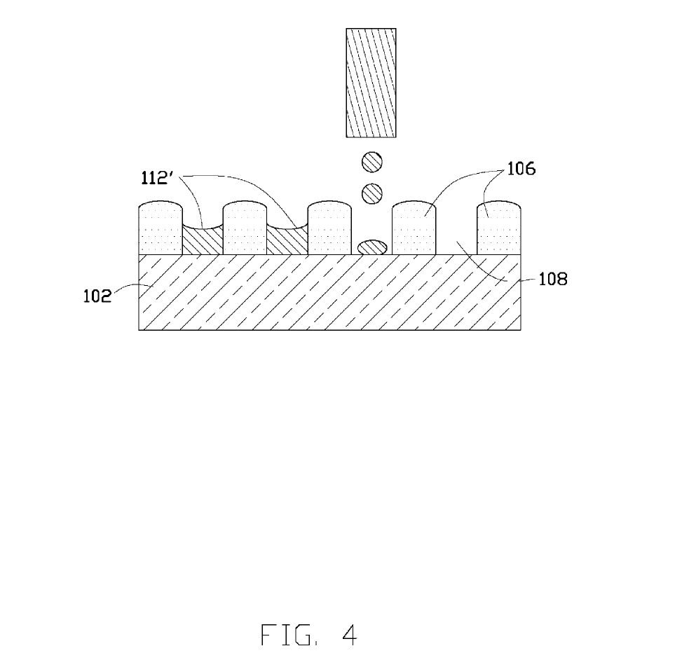

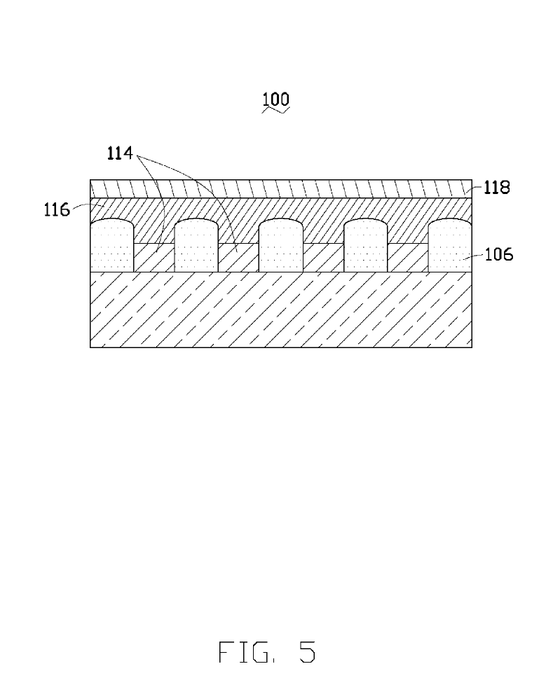

Referring to FIGS. 2 to 6, a method for manufacturing a color filter 100 according to a second preferred embodiment is shown. The method includes the steps of:
(1) forming a black matrix 106 on a substrate 102, the black matrix 106 defining a plurality of spaces 108 therein;
(2) depositing ink 112 in the plurality of spaces 108; and
(3) solidifying the ink 112 to form a plurality of color stripes 114.

In step (1), the substrate 102 is a transparent substrate, such as a glass substrate. The black matrix 106 includes carbon black in a proportion by weight from 5% to 55%, polymer in a proportion by weight from 15% to 95%, and additives in a proportion by weight of less than or equal to 40%.

the black matrix 106 is made by the following steps: applying an organic black photoresist layer onto a upper surface of the substrate 102 using a slit coater or a spin coater (not shown); exposing the photoresist layer using a photomask with a predetermined black-matrix pattern; developing the photoresist layer to remove non-black-matrix-pattern stripes of the photoresist layer; solidifying the photoresist layer so as to form the black matrix 106 on the substrate 102.

A thickness of the black matrix 106 ranges from 1.2 to 10 microns, and is preferably about 1.5 to 6 microns. Optical density of the black matrix 106 can be 3 or more.

Preferably, in the embodiment, the black matrix 106 has an outwardly curved top surface 1062, as shown in FIG. 2. The top surface 1062 can be formed by design of the photo mask and parameters for exposing and developing. Mixing of different-colored inks deposited in neighboring spaces 108 in the later steps can be avoided through use of the black matrix 106 with outwardly curved top surfaces 1062. The top surface 1062 of the black matrix 106 can be pyramid-shaped, conical-shaped. Also, the black matrix 106 can have an inwardly curved top surface instead of the outwardly curved top surface 1062. The top surface 1062 of the black matrix 106 can be basin-shaped. Generally, the surface 1062 of the black matrix 106 between every two spaces 108 has stripes of at least two different heights.

In step (2), ink 112 is deposited using a ink-jet device 110 into each space 108 to form ink layers 112. The ink-jet device 110 can be a thermal bubble ink-jet device or a piezoelectrical ink-jet device.

The substrate 102 moves relatively to the ink-jet device 110 so as to finish depositing the ink 112 into the spaces 108 defined by the black matrix 106.

In step (3), the ink layers 112 can be solidified by a solidifying device (not shown), such as a heating device or a light-exposure device, to form color stripes 114. The light-exposure device can be an ultraviolet light source. A heating device and a vacuum-pumping device can also be used for solidifying the ink layers 112 in the spaces 108 defined in the black matrix 106.

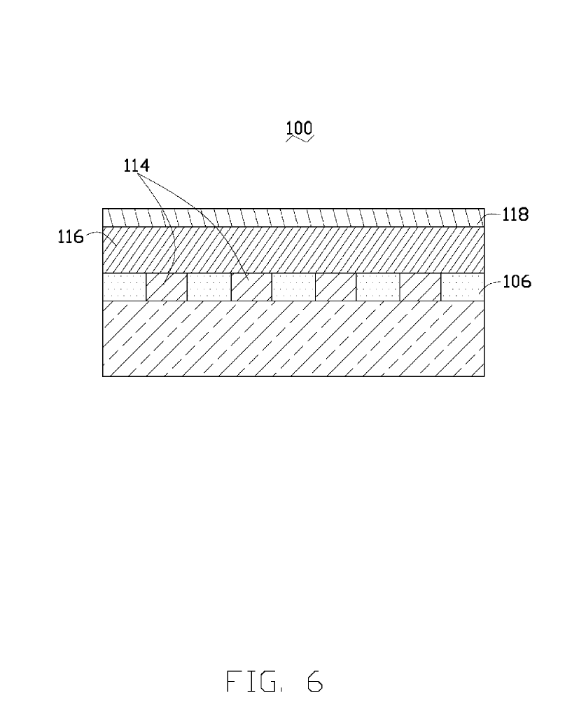

Referring to FIG. 6, an addition step following the step (3) for forming a protective layer 116 or an electrically conductive layer 118 may be performed. The portion of the black matrix higher than the color stripe 114 can be removed using a grinding method or an etching method before the protective layer 116 or the electrically conductive layer 118 is formed thereon. The protective layer 116 can be coated using a slit coating process or a spin coating process. The electrically conductive layer 118 can be deposited using a sputtering process. In addition, the protective layer 116 and the electrically conductive layer 118 can be formed on the black matrix 106 and the color stripe 114 sequentially.

The protective layer 116 is covers the black matrix 106 and the color stripes 114 for protection against humidity, pollution-resistance, oxidation-proof and a smoothness of the color stripes 114. The protective layer 116 is selected from the group consisting of polyimide resin, epoxy resin, acrylic resin and polyvinyl alcohol resin.

The black matrix of the color filter provided by the preferred embodiment can achieve the same effect as the banks used in a conventional method for manufacturing a color filter for avoiding mix of different-color ink depositing in neighboring spaces. Therefore, a forming step of banks on the black matrix may be omitted, thus simplifying production.

A method for manufacturing a color filter according to a third embodiment includes the steps of: providing a photoresist material comprising carbon black in a proportion of the solidifiable content by weight from 5% to 55%; a material selected from the group consisting of monomer, oligomer, and polymer, the material being in a proportion of the solidifiable content by weight from 15% to 95%; and additives in a proportion of the solidifiable content weight of less than or equal to 40%; applying the photoresist material on a substrate; forming a black matrix by a photolithographic process, the black matrix defining a plurality of spaces therein; depositing ink in the plurality of spaces; and solidifying the ink to form a plurality of color stripes.

More-detail steps and advantages of the method for manufacturing a color filter according to the third preferred embodiment is similar to those of the method for manufacturing a color filter according to the second preferred embodiment. Those skilled in the technical field can refer to the method for manufacturing a color filter according to the second preferred embodiment.

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. A color filter, comprising:
a substrate;
a black matrix formed on the substrate, the black matrix defining a plurality of spaces therein, the black matrix having a composition comprising:
carbon black in a proportion by weight from 5% to 55%;
polymer in a proportion by weight from 15% to 95%; and
additives in a proportion by weight of less than or equal to 40%; and
a plurality of color stripes respectively formed in the spaces.

2. The color filter as claimed in claim 1, wherein the substrate is a glass substrate.

3. The color filter as claimed in claim 1, wherein a thickness of the black matrix is in the approximate range from 1.2 to 10 microns.

4. The color filter as claimed in claim 3, wherein the thickness of the black matrix is in the approximate range from 1.5 to 6 microns.

5. The color filter as claimed in claim 1, wherein the black matrix has an outwardly or inwardly curved top surface.

6. The color filter as claimed in claim 1, wherein the proportion by weight of the carbon black is in the approximate range from 15% to 45%.

7. The color filter as claimed as claim 1, wherein the proportion by weight of the polymer is in the approximate range from 25% to 85%.

8. The color filter as claimed in claim 1, wherein the additives comprises an initiator and/or dispersant.

9. A method for manufacturing a color filter, comprising the steps of:
forming a black matrix on a substrate, the black matrix having a composition comprising:
carbon black in a proportion by weight from 5% to 55%;
polymer in an proportion by weight from 15% to 95%; and
additives in an approximate proportion by weight of less than or equal to 40%, the black matrix defining a plurality of spaces therein;
depositing ink in the plurality of spaces; and
solidifying the ink to form a plurality of color stripes.

10. The method as claimed in claim 9, wherein the ink is deposited using an ink-jet device.

11. The method as claimed in claim 10, wherein the ink-jet device is a thermal bubble ink-jet device or a piezoelectrical ink-jet device.

12. The method as claimed in claim 9, wherein the ink is solidified using a heating device and a vacuum-pumping device.

13. The method as claimed in claim 9, wherein the ink is solidified using a heating device or a light-exposure device.

14. The method as claimed in claim 13, wherein the light-exposure device is an ultraviolet light source.

15. The method as claimed in claim 9, wherein the proportion by weight of the carbon black is in the approximate range from 15% to 45%.

16. The method as claimed in claim 9, wherein the proportion by weight of the polymer is in the approximate range from 25% to 85%.

17. The method as claimed in claim 9, wherein the additives comprises an initiator and/or dispersant.

18. The method as claimed in claim 9, wherein the black matrix is formed by a method comprising the steps of:
applying a photoresist layer on the substrate;
exposing the photoresist layer; and
developing the photoresist layer to form a patterned photoresist layer serving as the black matrix.

19. The method as claimed in claim 9, wherein a thickness of the black matrix is in the approximate range from 1.2 to 10 microns.

20. The method as claimed in claim 19, wherein a thickness of the black matrix is in the approximate range from 1.5 to 6 microns.

21. The method as claimed in claim 9, wherein the black matrix has an outwardly or inwardly curved top surface.

22. A method for manufacturing a color filter, comprising the steps of:
providing a photoresist material comprising carbon black in a proportion of the solidifiable content by weight from 5% to 55%; a material selected from the group consisting of monomers, oligomers, and polymers, the material being having a proportion by of the solidifiable content weight from 15% to 95%; and additives in a proportion of the solidifiable content by weight of less than or equal to 40%;
applying the photoresist material on a substrate;
forming a black matrix by a photolithographic process, the black matrix defining a plurality of spaces therein;
depositing ink in the plurality of spaces; and
solidifying the ink to form a plurality of color stripes.

23. The method as claimed in claim 22, wherein the ink is solidified using a vacuum-pumping device, a heating device, a light-exposure device, or any combination thereof.

24. The method as claimed in claim 23, wherein the light-exposure device is an ultraviolet light source.

25. The method as claimed in claim 22, wherein a thickness of the black matrix is in the approximate range from 1.2 to 10 microns.

26. The method as claimed in claim 25, wherein a thickness of the black matrix is in the approximate range from 1.5 to 6 microns.

27. The method as claimed in claim 22, wherein the proportion by weight of the carbon black is in the approximate range from 15% to 45%.

28. The method as claimed in claim 22, wherein the proportion by weight of the monomer, the oligomer, or the polymer is in the approximate range from 25% to 85%.

29. The method as claimed in claim 22, wherein the polymer is selected from the group consisting of polymethyl methacrylate, and monomer, or oligomer comprising trimethylolpropane triacrylate, pentaerythritol triacrylate, pentaerythritol tetraacrylate, dipentaerythritol hexaacrylate, dipentaerythritol hexysaacrylate or any combination thereof.
